(19) United States
(12) Patent Application Publication
(10) Pub. No.: US 2006/0085268 A1
(43) Pub. Date: Apr. 20, 2006

(54) Access to product supplemental information, in a store

(75) Inventors: Richard L. Imendorf, Sun Valley, CA (US); Karen R. Imendorf, Sun Valley, CA (US)

Correspondence Address: WILLIAM W. HAEFLIGER, 201 S. LAKE AVE, SUITE 512, PASADENA, CA, 91101, US

(73) Assignee: RKI Corporation dba Retail Media Solutions

(21) Appl. No.: 10/964,932

(22) Filed: Oct. 15, 2004

(51) Int. Cl. G06Q 20/00; G06Q 30/00; G06G 1/14

(52) U.S. Cl. 705/16; 705/22; 705/26

(57) ABSTRACT

The method of assisting customers in a store, that includes providing one or more customer accessible terminals (CATS) in a store; providing supplemental information concerning a product in the store, the information being accessible by use of the terminal to scan a code associated with the product; providing an indicator at the product location in the store, for indicating that such product supplemental information is indeed accessible and available; and, pursuant to observation of the indicator, using the terminal to scan the code, thereby to gain access to that supplemental information, for display or use thereof.

### BACKGROUND OF THE INVENTION

This invention relates generally to systems management, and more specifically to IT (information technology) systems management within the retail industry.

The retail store and manufacturing industry utilizes several processes specifically designed to retrieve a variety of product merchandising information from central IT computer databases. Included in these processes are different types of customer accessible terminals (hereinafter referred to as CAT) that are operated by the customer (shopper) to retrieve pre-programmed information, for the customer's review, to gain product knowledge or become aware of special offerings on a specific product and/or related product(s), as determined by the retail store, product manufacturer or any other designated entity (such as advertising and marketing agencies, etc.).

The product information can be stored in the CAT and updated (downloaded) periodically from a central computer database, or can be stored and retrieved (downloaded) periodically from a central computer database, or can be stored and retrieved (downloaded) directly from the central IT database. The CAT's are physically located in different parts of the store for customer accessibility (physical location and the number of CAT's can vary from store to store). The information can be visually displayed in different formats such as alphanumeric, graphic (color or monochrome), video, Mpeg, etc. and with or without sound (audio).

These CAT's are customarily known as Price Checkers, Price Verifiers, Product Information Terminals, Customer Verification Terminals, Kiosks, etc. They also fall within retail store marketing and sales categories known as Point of Purchase (POP), Point of Sale (POS), Point of Retrieval (POR), etc. (These names or sales and marketing categories are not necessarily limited to the descriptions given above.) The decoding technologies include, but are not limited to bar code scanners (either laser or optical type) and/or radio frequency identification devices (RFID), also known as smart tags, using radio transceivers and microprocessors. These technologies can either identify the product code embedded in the bar code(using such industry standard bar codes as UPC-E and -A, EAN-8 and -13, Jan-8 and -13, UPC P2, UPC P5, Interleaved 2 of 5, Code 128, Code 93, Code 39 and GTIN Codes, etc., or code programmed on the RFID microprocessor. Using the CAT, the customer “scans or reads” the bar code and/or, if using RFID technology, receives the embedded product code or product information by radio signal.

Traditionally, CAT terminals have been used to give customers access to information such as product description and pricing. As both the hardware and software technologies improve, the type and variety of information formats at these terminals is increasing to include a variety of other information such as advertising, technical specifications, product learning, warnings, product instructions, referrals to other products, cross sales, discounts or special sales offers and other information that the product manufacturer or retail store outlet wishes to convey to the customer who knowingly scans the product or product coupon for additional product information other than price and description information. The terminals can convey this information visually on electronic LCD type, Plasma type or CRT type displays (either in color or monochrome) or be printed on paper from printers. The information can be displayed in a variety of ways such as in graphic form, video form, alphanumeric form, etc. (or any combination thereof) with or without sound. The information source (database) may be a main computer at the same location as the terminal or located at remote location and accessed by Internet, radio (RF) signals, telephone lines, satellite, or any other means associated with data communications.

Since there are hundreds of thousands of retail products available for sale, it is not practical or desirous or necessarily mandatory that all manufacturers or store outlets provide supplemental product information for all products. Therefore, not all products will necessarily have supplemental information, other than description and pricing.

Other than the product description and price typically associated with bar codes and RFID's, the customer is unable to determine from the product packaging, price tags, smart tags, merchandise displays (such as electronic tags, shelving, racks, stands, counters, etc.) or from discount/special offer coupons if supplemental product information is available for the product.

In other words, the customer cannot determine from the product packaging or from shelf labeling alone if there is supplemental information associated with a product such as special offers, product use, application notes, specifications, etc.

### SUMMARY OF THE INVENTION

It is a major object of the invention to provide a solution or solutions to the above described problems and needs. Basically, the invention is embodied in a method for assisting customers in a store, and includes the steps:

a) providing one or more customer accessible terminals (CATS) in a store,

b) providing supplemental information concerning a product in the store, said information being accessible by use of the terminal to scan a code associated with the product,

c) providing an indicator at the product location in the store, for indicating to the customer that such product supplemental information is indeed accessible and available,

d) and, pursuant to observation of the indicator, using the terminal to scan said code, thereby to gain access to that supplemental information, for display or use thereof.

As will be seen, the indicator is typically provided on one of the following:
i) the product,
ii) a coupon associated with the product.

It is another object of the invention to provide the scannable code to be carried by the product (as on a label or tag, or directly on the product package), or on a coupon associated with the product; and the product or coupon identified by the indicator, is typically transported to a CAT, for scanning.

A further step of the method includes initially locating the indicator at the product location in the store, said supplemental information associated with the indicator being received into a data base to be accessed in response to said scanning. For example, a store clerk may apply the indicator to the product on the shelf, or to a shelf zone or other region associated with the product, for easy visual recognition by the customer. The indicator may be in the form of a visually distinctive symbol.

Provision of the indictor contemplates other means or identification to notify, advise, inform or alert the customer (shopper) that there is supplemental information available on the product if the product is scanned at one of the CAT's located within the retail store. This identification can be used in association with the bar codes or RFID identification by being made part of the bar code label or RFID tag itself; or, it can be shown separately from the bar code label or RFID tag on the product package or packaging, printed or affixed, displayed on product merchandising shelves, racks, hangers or separate stand alone devices specifically designed and installed to display or advertise the identifying mark(s).

This method applies to any type and means of identification (such as an image, mark, symbol, word, group of words or phrase, in any language and any alphanumeric or symbol combination, etc.) that informs and enables the customer to identify those products that can be scanned for supplemental product information regardless of the scanning method or from where the supplemental information is stored and retrieved.

The word “identifier” will be used herein to mean, but not necessarily be restricted to, any type of identification that informs and enables the customer to identify those products that can be scanned for product information.

The word “product” will be used herein to mean, but not necessarily restricted to, any an all consumer related products and goods regardless if the product or good is perishable, non-perishable, dry good, food, etc. There is no distinction as to the current type or future type of products and goods that can be identified with this identifier.

The word “supplemental” will be used herein to mean, but not necessarily be restricted to, any variety of other information such as advertising, technical specifications, product learning, warnings, product instructions, referrals to other products, cross sales, discounts or special sales offers and other information that the product manufacturer and/or retail store outlet intends to convey to the customer when he/she knowingly “scans” the product for additional product information at a CAT, other than price and description information.

When the customer sees the identifier affixed or printed on the product, product packaging or merchandising shelves, display cases or racks, etc., he/she will immediately know that there is supplemental product information (such as advertising, discounts, specifications, etc.) that can be accessed using one of the CAT's. For products without the identifier, the customer will understand that there is no supplemental information (other than pricing and description normally associated with bar codes and RFID's) when the product is scanned at the terminal. This will help the customer to immediately identify those products that have additional information that is assessable at the store CAT's. It will also help the product manufacturers and/or retail stores identify those products that have additional information they wish the consumer to view.

The identifier or indicators optimize the efficiency of using CAT's for displaying supplemental product information and help the customer identify the product for which supplemental product information exists.

The customer is informed (educated), by the individual retail store(s) or the product manufacturer(s) using the herein product information system, to look for the identifier as a way of knowing that there is supplemental product information available to the customer when the product is scanned at one of the in store CAT's.

The customer can be educated to this process and made aware to look for the identifying labels when shopping through in-store advertising, announcements and/or public advertisements (such as the radio, television and print media, special offerings, customer bulletins, etc.) by either the product manufacturers or retail outlets.

These and other objects and advantages of the invention, as well as the details of an illustrative embodiment, will be more fully understood from the following specification and drawings, in which:

### DRAWING DESCRIPTION

FIG. 1 shows examples of various types of identifiers or indicators, at A-E; and FIG. 1a shows an indicator on a product;

FIG. 2 is a plan view diagram of the interior of a retail store;

FIG. 3 is an elevation showing customer transport of an indicated product to a CAT, for scanning of code; and

FIG. 4 is a block diagram showing method steps, and system integration.

### DETAILED DESCRIPTION

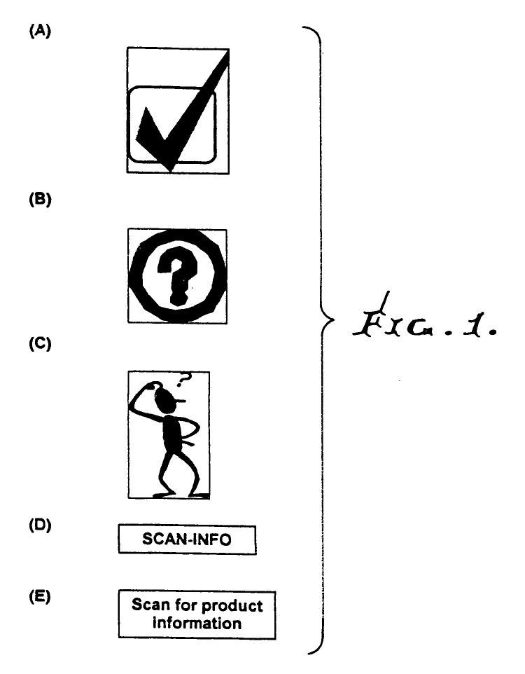

Referring first to FIG. 1, it shows at A-E various representative indicators or identifiers that may be placed onto a product, a coupon, or onto store shelf regions where the products are to be identified as having associated supplemental information to be accessed by a shopper.

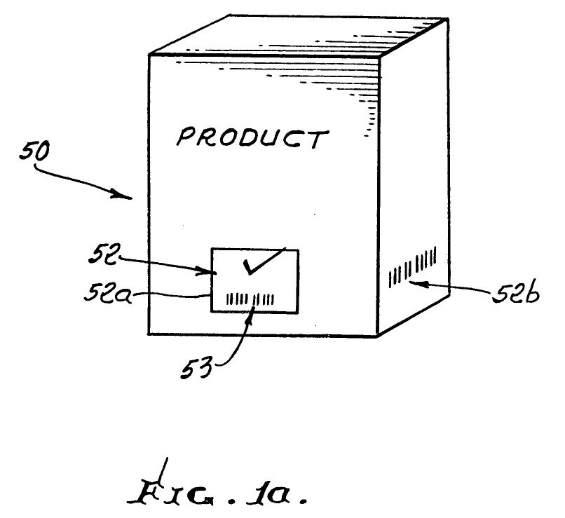

FIG. 2 shows a representative store interior layout, in which the method of the invention is to be performed. It also describes or represents a system embodying the invention. The following steps are performed:

Step 1. Consumers are informed through various types of print or electronic (TV and radio) media advertising, special announcements, bulletins, word of mouth, in store advertising or postings, etc. that supplemental product information is available on certain designated products when scanned at a CAT. These products are identified by an identifier (symbol, word or phrase, etc., see FIG. 1) that the customer will then recognize when shopping. The advertisement can fully detail the type of supplemental information available, such as discount information, recipes, instructions, special offerings, etc.

Step 2. When shopping, the customer (shopper) sees on the product, product packaging or product shelves, etc. the special identifier that identifies that there is additional product information available if the product is scanned at one of the store CAT's. Alternatively, the customer has with him or her, or are otherwise available, store coupons that he/she can scan at a CAT to retrieve information.

Step 3. The customer (shopper) takes the product(s) or coupons to one of the CAT's located within the store and scans the product. Product information is accessed by the CAT for the customer's convenience in reviewing. That information may be displayed at the CAT, or otherwise displayed.

In the above, a database in which supplemental information is stored, for access via the CAT, is shown at 100. Note in FIG. 2 the various customer 101 movements from the product display stands or racks 102 to the nearest CATs 103, for scanning. If a product is transported in this way, it is either purchased at checkout 109 or is returned after code scanning, to its stand or rack. The CAT will also be understood as providing a CRT or other display means to display the accessed information.

The system of the invention includes:

a) one or more customer accessible terminals (CATS) in a store,

b) a data base for storing supplemental information concerning a product or products, to be accessed by use of a terminal (CAT) to scan a code associated with the product;

c) a marker 52c in the store or at the product location in the store, for indicating that such product supplemental information is indeed accessible and available,

d) whereby, pursuant to observation of the indicator, the terminal is usable to scan said code thereby to gain access to that supplemental information, for display or use thereof.

The invention contemplates use of special offer or product discount coupons that are dispensed within the store and/or are available in print form from print advertisements and the internet. By using an identifying label or identifier on the product or product coupon, the customer will know to scan the product for additional (or supplemental) information associated with that specific product.

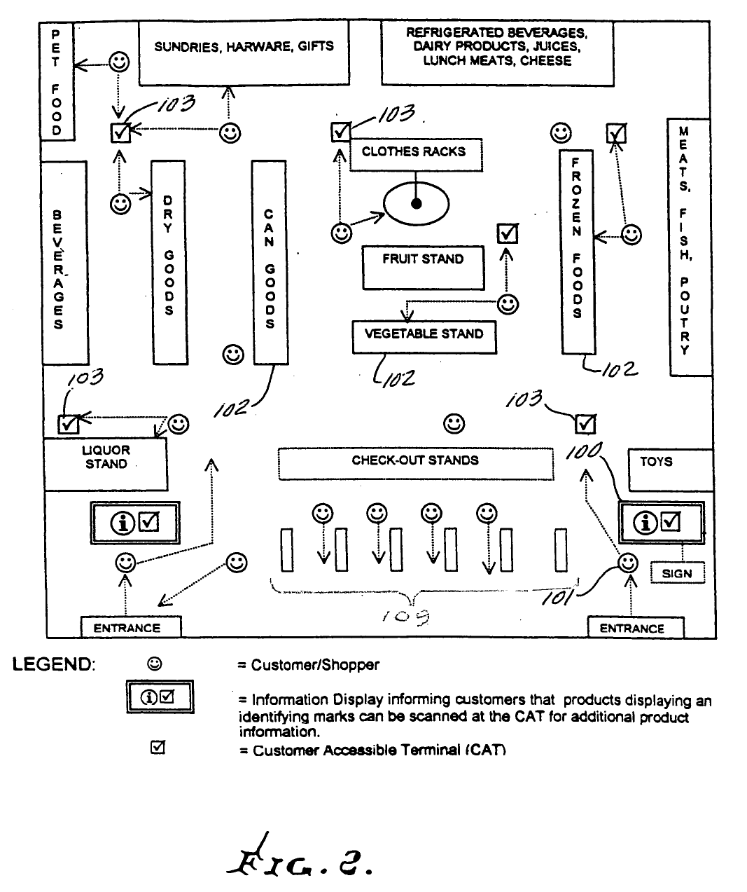

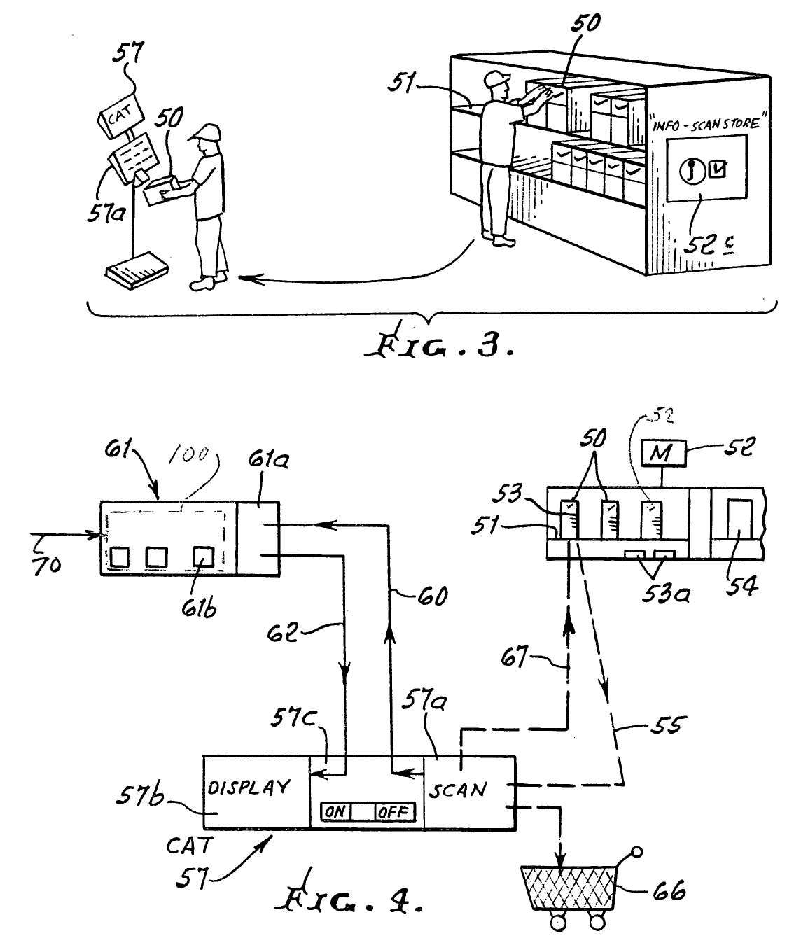

FIGS. 3 and 4 show method steps and systems operation. Store items or products 50, on shelf 51 to be sold, are designated by identifiers 52 on products 50 and/or by markers 52c as having associated supplemental information available. See also FIG. 1a. That information may be accessed by readout of special bar coding or RFID smart tags 53 on items 50 or on coupons 53a. Store items not so indicated with identifiers are shown at 54.

A customer notes the indicator 52 on product 50 or marker 52c, and being curious, transports one of the products 50, via path 55, to the proximal site of a CAT unit 57. That unit typically has a scanner section 57a, a display section 57b, and a control section 57c.

When the bar code 53 on item 50 or 53a is scanned at 57a, (unit 57 being ON), the positive accessing signal generated in 57a is transmitted at 60 to the control section 61a of the supplemental data base unit 61. The bar code 53 may be provided on a label 52a carrying indicator 52 or be separate 52b. Such control effects selection of information packet stored at 61b and its transmission at 62 to the unit 57, for display at 57b. After the customer reads such displayed supplemental information, the unit usually self-deactivates after an appropriate time delay. The customer then places the item 50 in cart 66 prior to check-out at 109 in FIG. 2, or returns it to the shelf, via path 67. These steps preferably occur prior to check-out at 109 in FIG. 2.

Inputting of supplemental information, as referred to, into the data base is indicated at 70, and may allow for up-dating.

I claim:

1. The method of assisting customers in a store, that includes
a) providing one or more customer accessible terminals (CATS) in a store,
b) providing supplemental information concerning a product in the store, said information being accessible by use of the terminal to scan a code associated with the product,
c) providing an indicator at the product location in the store, for indicating that such product supplemental information is indeed accessible and available,
d) and, pursuant to observation of the indicator, using the terminal to scan said code, thereby to gain access to that supplemental information, for display or use thereof.

2. The method of claim 1 wherein said indicator is provided on one of the following:
i) the product,
ii) a coupon associated with the products.

3. The method of claim 1 wherein said code is provided on the product.

4. The method of claim 1 wherein the product is transported to said terminal in the store, for scanning.

5. The method of claim 3 wherein the product is transported to said terminal in the store, for scanning.

6. The method of claim 1 wherein said indictor is provided in the form of a visually distinctive symbol, word, phrase, characters, or group of words.

7. The method of claim 1 wherein said CATS are strategically located in a store, for proximity to products or coupons to be scanned.

8. The method of claim 1 including initially locating the indicator at the product location in the store, and inputting said supplemental information associated with the indicator into a data base to be accessed in response to said scanning.

9. The method of claim 1 including providing the indicator and the code on the product.

10. A system for accessing supplemental information associates with a product in a store, that includes
a) first means for indicating that a product in the store has associated supplemental descriptive information that can be accessed,
b) second means for scanning said first means to produce a signal to access said information,
c) a data base at which said supplemental information is stored, to receive said accessing signal,
d) and third means for receiving accessed information from the data base, for displaying said accessed information.

11. The system of claim 9 wherein said first means includes an indicator associated with the product a the product location in the store, said indicator characterized as visually observable by a customer, in one of the following positions:
i) on the product,
ii) associated with bar code on the product,
iii) on a coupon near the product,
iv) on a surface near the product.
